(19) United States
(12) Patent Application Publication
(10) Pub. No.: US 2019/0309134 A1
(43) Pub. Date: Oct. 10, 2019

(54) CLASS OF HYBRID AEROGELS WITH AN ULTRALIGHT NONPARTICULATE RETICULATED STRUCTURE AND A METHOD OF PRODUCING THE SAME

(71) Applicants: Sasan REZAEI, Toronto (CA); Chul B. PARK, Etobicoke (CA)

(72) Inventors: Sasan REZAEI, Toronto (CA); Chul B. PARK, Etobicoke (CA)

(21) Appl. No.: 15/946,960

(22) Filed: Apr. 6, 2018

(51) Int. Cl. C08J 3/075; C08L 83/10; C08G 77/20; C08K 3/22; C08J 3/24

(52) U.S. Cl. CPC C08J 3/075; C08L 83/10; C08G 77/20; C08K 3/22; C08J 3/24; C08K 2003/2227; C08K 2003/2244; C08J 2383/10; C08L 2312/08; C08L 2203/16; C08K 2003/2241

(57) ABSTRACT

The present invention relates to the manufacture of a new class of hybrid aerogels with a 3-D reticulated structure. First, the organic and inorganic components of the structure are distributed on a molecular level in such a way that all of the organic components of the precursor are chemically bonded to each other and to the inorganic component. Second, in the new hybrid aerogels, the pores are separated by solid walls like reticulated open-cell foams without the particulate solid parts and also the present invention is a process for preparing a hybrid aerogel without aging step having a nonparticulate-reticulated structure comprises of a polymeric precursor that is crosslinked by a linkage without forming particulate structure.

### FIELD OF THE INVENTION

The present invention relates to hybrid aerogels with a 3-D reticulated structure and also to a new generation of precursors that have a polymeric structure.

### BACKGROUND OF THE INVENTION

Aerogels (e.g., silica aerogel) are a class of porous materials with a 3-D network of aggregated particles. These are derived from wet gels that have solvent by using an extraction drying method such as supercritical CO₂ drying. There are three main aerogel categories: inorganic, organic, and hybrid. Inorganic aerogels generally consist of a metal oxide, such as silica or alumina. Organic aerogels, on the other hand, have a crosslinked polymeric framework. Hybrid aerogels include both organic and inorganic components.

Silica aerogels are the most well-known of the inorganic aerogels and hybrid aerogels containing an inorganic component. This is due to their easy manufacturing process. Sodium silicate was used by Kistler [4,5] in 1930 as the precursor to make a silica wet gel. However, in 1968 alkoxysilanes were introduced as better precursors [6]. The most common precursor is tetraorthoethyl silicate (TEOS). It forms a wet gel through a sol-gel reaction. A similar approach was also taken with the other metal alkoxy compounds (e.g., titanium) to make a different type of aerogel with different properties [7-9].

Aerogels possess low density, large porosity, low thermal conductivity, and a high specific surface area. These attractive characteristics make them a promising candidate for use in a wide range of applications that include filtration, thermal insulation, catalyst support, and so forth. However, their practical applications have always been limited by their poor mechanical properties. These difficulties are located in their interparticle regions. Although the silica connections inside the particles are very strong, the bonding between the particles is weak [10,11]. To enhance the mechanical properties of silica aerogels, it is crucial to strengthen their interparticle regions, and different techniques have been undertaken to address this challenge.

Many researchers have tried to improve the overall integrity and, consequently, the mechanical properties of the silica aerogel by creating a neck structure between the particles, typically through an aging process with solvents [12-14]. And the efficiency of the aging process involved in this effort depends greatly upon the type of solvent used and the temperature selected. A solvent with a lower surface tension was found to more effectively enhance the mechanical properties. At a low temperature of below 100° C. [15], the aging process needs several days to show any tangible improvement in this area. On the other hand, aging caused an increase in both the pore size averages and their densities by means of a “coarsening” process [15]. This phenomenon can increase the thermal conductivity of silica aerogels or even reduce their mechanical properties sometimes.

Physically mixing a polymer into a silica sol prior to gelation has been another strategy [16]. However, it was shown that in a dispersed state, the weakly bonded polymer could easily be washed out during either the solvent exchange or the drying stage. The physical hybridization of polymer and silica particles did not prove successful.

More recently, the idea of connecting particles by means of covalently bonded polymeric chains to other particles has gained more attention. Several types of polymers such as epoxides [17,18], polyacrylonitrile [19], polyurea [20], polyurethane [21,22], and polystyrene [23,24] have been studied to date. Despite the considerable improvement that resulted in the silica aerogels' mechanical properties, this method increased the aerogels' densities [17,20,23,25,26], which consequently increased their total thermal conductivity.

The polymer-crosslinked aerogel method aimed to enhance the mechanical properties of aerogels by modification of the structure of an already made gel. However, some studies focused on altering the precursor materials from which the aerogels are formed. Bridge siloxanes are widely studied in this context [27-31]. A bridge siloxane has a general formula of (R₁O)₃SiR₂Si(OR₁)₃ where R₁ can be anything and a bridge siloxane R₂ can be an aryl (which can include phenyl) or alkyl (which includes alkane). The R₂ structure plays a key role in determining the mechanical properties of the aerogel. With a more rigid group such as phenyl for R₂, Young's modulus increases, while an alkane chain for R₂ increases the bendability of the aerogel [29, 32].

More recently, Kanamori et al. at Kyoto University, use a polyvinylsilsesquioxane (PVSQ) structure to create super thermal-insulating hybrid aerogels [33]. Vinyl trimethoxy silane (VTMS) hydrolytically polymerized in an acidic solution and after gel formation through a free radical polymerization, the vinyl groups on the surface of silicas are connected to each other to provide more integrity. This aerogel is featured with short-ranged organic connections within and between the particles. Because of many connections, the stresses are distributed more uniformly. The individual particles and the overall structure are more flexible and ductile than the 1^{st}-generation silica aerogels because of the less number of silica connections. The main difference between the PVSQ technology and the present invention is that, the structure of the PVSQ aerogel has a short-range connectivity as shown in their paper [33], whereas the whole structure of the aerogel in the present invention is connected together through silica bonding between polymeric chains (FIGS. 2A-2B), like a thermoset molecular structure.

Finally, in the most recent work, Kanamori et al. changes the sequences of their aerogel manufacturing process [34]. They start from vinylmethyldiethoxysilane (VMDMS), and they polymerize the molecule, and then through the sol-gel reaction, they create the polyvinylpolymethylsiloxane (PVPMS) aerogel. Although, in this work, the manufacturing process of their precursor for the PVPMS aerogel looks similar to the processing technology of our precursor for the claimed aerogel, the final structure of the resultant aerogel is completely different. They create very fine particles ranging from 24 nm to 50 nm to form a network with porosity. In other words, their aerogel structure, still, has a particle-to-particle structure, resembling to the conventional aerogels. However, in our newly invented aerogel, the structure is fully continuous and reticulated, without any particles.

FIGS. 1A, 1B, 1C, 1D and 1E show the prior art structure of 1^{st}-generation (particulate) aerogel, a polymer-crosslinked aerogel, a bridge siloxane aerogel, PVSQ aerogel and PVPMS aerogel.

### SUMMARY OF THE INVENTION

The present invention relates to the manufacture of a new class of hybrid aerogels with a 3-D reticulated structure. First, the organic and inorganic components of the structure are distributed on a molecular level in such a way that all of the organic components of the precursor are chemically bonded to each other and to the inorganic component. Meanwhile, there is no solely organic and/or inorganic phase such as is found in polymer-crosslinked aerogels. Second, in the new hybrid aerogels, the pores are separated by solid walls like reticulated open-cell foams without the particulate solid parts. Although, such a structure has been seen and utilized in organic aerogel [1,2,3], it has not been achieved with an inorganic aerogel nor with hybrid aerogels.

In addition, the present invention relates to the manufacture of a new generation of precursors that have a polymeric structure. These new precursors have a backbone of the polymeric chain such as polyethylene (PE) (organic) with large repetition of functional side groups, which can turn into metal oxides such as silica after a secondary reaction such as the sol-gel reaction (inorganic). A nanostructured wet gel, both with and without a reinforcing agent, is created from both the polymeric precursors and a solvent such as ethanol. Then, the solvent is removed through a drying process, such as supercritical drying or freeze drying. This produces a final continuous nanoporous hybrid aerogel with much more enhanced mechanical properties while maintaining other functional properties such as the insulation property. The newly structured aerogels with unique properties, the precursors' formulation and the used synthesis methods of the precursors, and the overall manufacturing processes in relation to the new aerogel structure, are claimed.

### BRIEF DESCRIPTION OF THE FIGURES

Embodiments herein will hereinafter be described in conjunction with the appended drawings provided to illustrate and not to limit the scope of the claims, wherein like designations denote like elements, and in which:

FIG. 1A shows the precursor and the final aerogel structure and interparticle bonding of the 1^{st}-generation silica aerogel;

FIG. 1B shows the precursor and the final aerogel structure and interparticle bonding of a bridge siloxane derived aerogel;

FIG. 1C shows the precursor and the final aerogel structure and interparticle bonding of a polymer crosslinked silica aerogel;

FIG. 1D shows the precursor and the final aerogel structure and interparticle bonding of a PVSQ derived aerogel;

FIG. 1E shows the precursor and the final aerogel structure and interparticle bonding of a PVPMS aerogel;

FIG. 2A shows the structure of the newly invented aerogel (*SD: spinodal decomposition);

FIG. 2B shows the structure of crosslinked polymeric precursor without void fraction;

FIG. 3 shows the schematic of the processing for the newly invented aerogel;

FIG. 4 shows the TEM image of a PE-based silica aerogel with a density of 0.077 g·cm⁻³;

FIG. 5 shows pore size distribution of PE-based silica aerogel at various densities;

FIG. 6 shows the comparison of the compressive moduli of the newly invented PE-based aerogels and those of the conventional aerogels at various densities;

FIG. 7 shows the comparison of the total thermal conductivities of the newly invented PE-based aerogels and those of the existing various silica aerogels and PVPMS aerogels at various densities;

FIG. 8 shows comparison of the compressive modulus of newly invented PE-based hybrid aerogel from Example 1 with Di-tert-butyl peroxide thermal initiator and those of from Example 2 with dicumyl peroxide at various densities;

FIG. 9 shows comparison of the total thermal conductivity of newly invented PE-based hybrid aerogel from Example 1 with Di-tert-butyl peroxide thermal initiator and those of from Example 2 with dicumyl peroxide at various densities from Example 2), and

FIG. 10 shows total thermal conductivity of PMMA-based aerogel from Example 5.

The invented technology is used to produce a new series of nonparticulate reticulated hybrid aerogels. Some nonparticulate reticulated hybrid aerogels and their processing technology are described in more detail below in several examples. This includes unrestricted working examples.

### DETAILED DESCRIPTION OF THE INVENTION

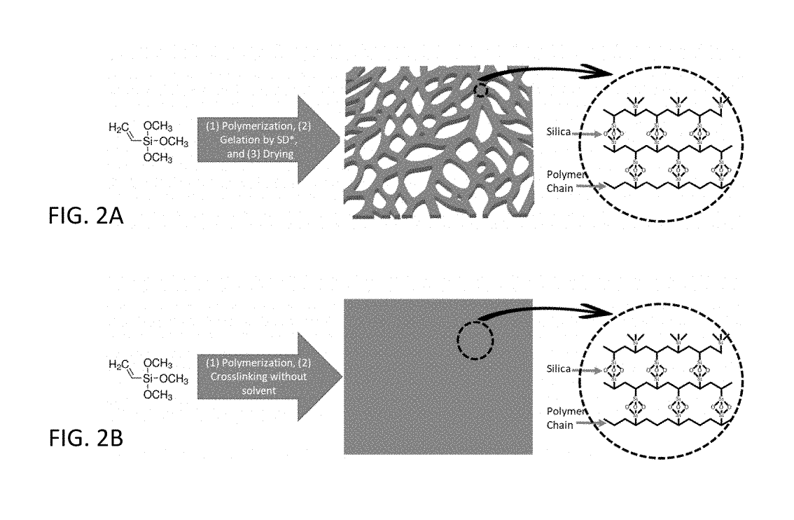

The present invention is a new class of hybrid aerogel, which is characterized by a unique 3-D nonparticulate reticulated structure with a repeating unit. Although the primary starting materials in some ways resemble other types of aerogels, especially polymer-crosslinked aerogels, this approach has produced a novel class of aerogels, which have a continuous 3-D nonparticulate, reticulated network structure as shown in FIGS. 2A and 2B.

One central issue in the gelation step is to avoid binodal phase decomposition in order to prevent the creation of a particulate structure in the hybrid aerogel. This makes this new class of hybrid aerogels very different from the previous, particulate hybrid aerogels, wherein individual particles have been deposited upon one another or have been connected by polymer chains. This new invention's 3-D nonparticulate, reticulated structure offers significantly improved mechanical and insulation properties for the hybrid aerogel monoliths and hybrid aerogel composites.

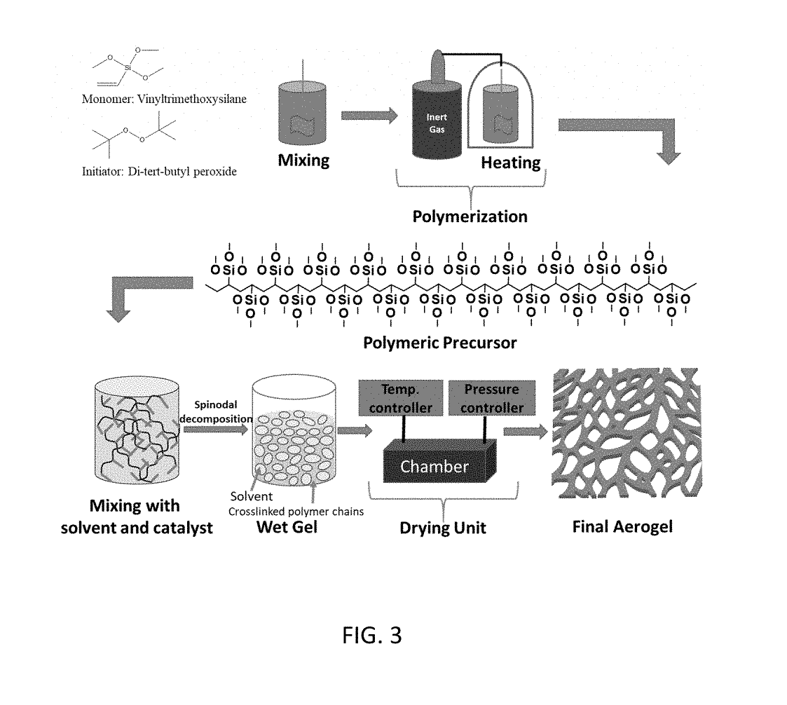

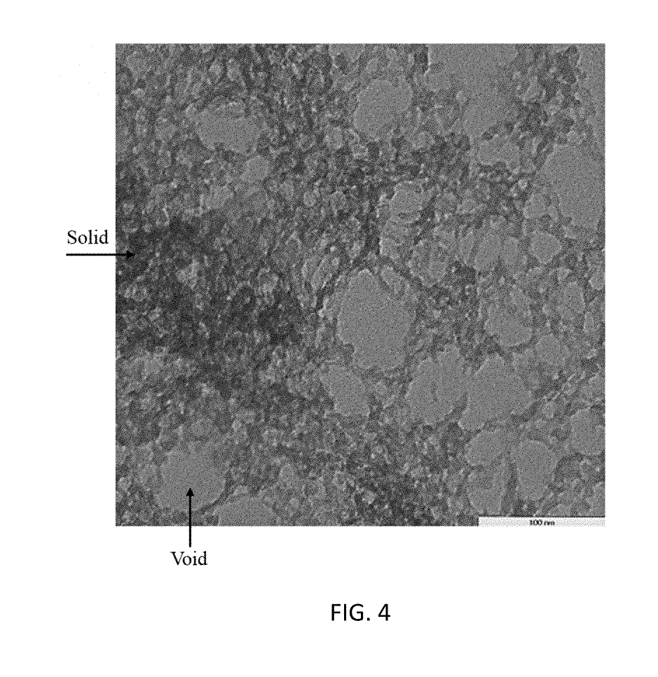

FIG. 3 shows a preparation method for a polymeric precursor (a PE-based precursor as an example) and the final aerogel schematically. The degree of polymerization of the polymeric precursor is 20 in the figure. However, for practical applications, a higher degree of polymerization is better, preferably 70 to 140 (see examples 1 and 2).

### Precursor Materials

First, this invention involves the creation of a new class of precursors by which to produce aerogels with a 3-D reticulated structure. This novel class of precursors is described as polymeric precursors. These new precursors have a backbone of a polymeric chain such as PE (organic) with large repetition of functional side groups, which can turn into metal oxides such as silica after a secondary reaction such as the sol-gel reaction (inorganic).

There are two main differences between the precursors in the conventional aerogel and the precursor in this invention. First, the number of silicon atoms per each molecule of the conventional precursor is limited to one (for TEOS, for example) or two (for bridge siloxane). But the number of silicon atoms per each molecule of the new precursors in this invention varies in a wide range from 10 to 1000, preferably 20 to 200. Second, the location of silicon atoms is different. In the TEOS, the location of silicon is in the center of the molecule. For the bridge siloxanes, as one of the conventional precursors, the silicon atoms are located at both ends of the bridge, however, in the claimed precursors, silicon atoms are side groups which distributed along the chain.

In the PVPMS aerogel's precursor, the ratio of alkoxy silane groups per carbon atoms in the main backbone chain is 1, whereas in the newly invented aerogel's precursors, the ratio of alkoxy silane groups per carbon atoms in the main backbone chain could be anything less than 1.5. For instance, this ratio is 1.5 for the PE-based aerogel and 0.5 for the polyether-based aerogel.

The starting materials (monomer) prior to the polymerization process may be represented by the general formula which follows: (R₁O)_{4-X}M(R₂)_{X}. In this, the R₁O is a hydrolyzable group. It may be used to create covalent M-O-M bonding through the sol-gel reaction of the non-limiting examples of the R₁ that include CH₃, C₂H₅, and X can be 1, 2 or 3. The M is a metal, and non-limiting example of it include Si, Ti, Zr, and Al.

In one respect, the R₂ can have any structure. This can carry at least one functional group to start a polymerization reaction. Examples of the polymerization method include, but are not limited to, free radical polymerization, anionic and cationic polymerization, ring opening polymerization, click polymerization and atom transfer polymerization. The polymerization process could be a homopolymerization of a single polymerizable monomer such as a homopolymerization of vinyl trimethoxysilane or a copolymerization of a multicomponent system with at least one monomer having the defined structure of this invention. Examples include, but are not limited to, the copolymerization of vinyltriethoxy silane with an N-vinyl-2-pyrrolidone.

In another respect, the R₂ can form a group that is unable to start a polymerization process, but which can graft to functional groups on a polymer chain to form a polymeric precursor. For instance (3-aminopropyl) trimethoxysilane (APTMS) can graft to a polyacrylic acid chain. This occurs via the amine group's reaction to the carboxylic acid groups on the polyacrylic acid chains and forms a polymeric precursor which can trigger a subsequent sol-gel reaction.

### Processing

The manufacturing process for the newly invented aerogel consists of two steps. First, we make giant precursors separately in the preparatory stage by using various polymerization techniques. Then, we connect them through a sol-gel reaction in a shaping mold to complete the aerogel process. Since the sol-gel reaction removes all of the boundary features of the individual (giant) precursors, the final aerogel network structure cannot identify the boundaries of the used precursors. Therefore, the whole structure consists of one networked molecule.

Aerogels can be developed either in a binodal-decomposition to have a particulate structure, or in a spinodal-decomposition region to have a nonparticulate structure. Aerogels with a nonparticulate structure made in spinodal decomposition are rare. For example, only a few organic aerogels made out of polyamide, polyimide or polystyrene, have successfully demonstrated a nonparticulate structure obtained from spinodal decomposition in some narrow processing conditions [1-3]. Even the aerogels made out of these materials often times have a particulate structure because the phase decomposition typically occurs in the binodal region [35-37]. Thus, most organic aerogels have nucleation and growth of particles in the binodal region [38,39]. It should be also emphasized that there has been no nonparticulate structure observed from any hybrid or inorganic aerogels. All the previous hybrid and inorganic aerogels are developed in the binodal region and, therefore, they all have a particulate structure [5-20].

One unique difference in the present invention's processing technology is that we induce spinodal decomposition to create a nonparticulate structure for our hybrid aerogels. In order to promote spinodal decomposition, we use a very high concentration of a nonsolvent and catalyst. Example of nonsolvent include but are not limited, water (molar ratio of water/Si higher than 2 more preferably between 6 to 9). Consequently, our hybrid aerogels do not have a particulate structure but a nonparticulate, reticulated structure. It should be noted that the previous hybrid and inorganic aerogel technologies typically use a low molar ratio of catalyst-to precursor ranging from 0.005 to 0.03. For example, Kanamori et al. [34] used a 0.03 molar ratio of catalyst-to-precursor to produce a particulate structure. But our hybrid aerogel technology uses a much higher molar ratio of catalyst-to-precursor, typically ranging from 83 to 200 (or higher).

Another unique difference in the present invention's processing procedure is that the aging step is eliminated. Just because the new invention does not have a particulate structure, there is no need to have this aging step. The aging step provides connection between particles by creating neck for the particulate-structured aerogels. It is extremely important for particulate-structured aerogels to have connections between the particles before drying. Otherwise, the wet gels will collapse during the handling and drying stages. For instance, in the PVPMS aerogel processing, the aging step needs 4 days at least [34]. By contrast, our wet-gels are fully connected from the gel-formation step, and they can be transferred to the drying stage without the aging step.

In this disclosure, the monolithic wet gel and/or composite wet gel, which is a mixture of the polymeric precursor with the fiber(s) and/or the particle(s), form via the following sol-gel chemistry: A certain amount of polymeric precursor, either with or without fiber(s) and/or the particle(s), is dissolved in a predefined volume of a solvent or in a mixture of different solvents. Non-limiting examples of solvents include methanol, ethanol, propanol, acetone, and tetrahydrofuran. Subsequently, a high concentration of the water and catalyst must be added to the mixture to promote the spinodal gelation reaction. Non-limiting examples of the catalyst include ammonia, diluted hydrochloric acid, acetic acid, and dibutyltin diacetate. The gelation process can be controlled by adjusting the temperature, the catalyst concentration, and the type of solvent. This can be done in a batch or continuous process. In the batch process, the sol's and/or composite sol's entire volume is catalyzed, and the gelation process occurs simultaneously throughout the volume. In a continuous process, the sol and/or composite sol is catalyzed in a continuous stream prior to the gelation process.

### Unique Aerogel Structure

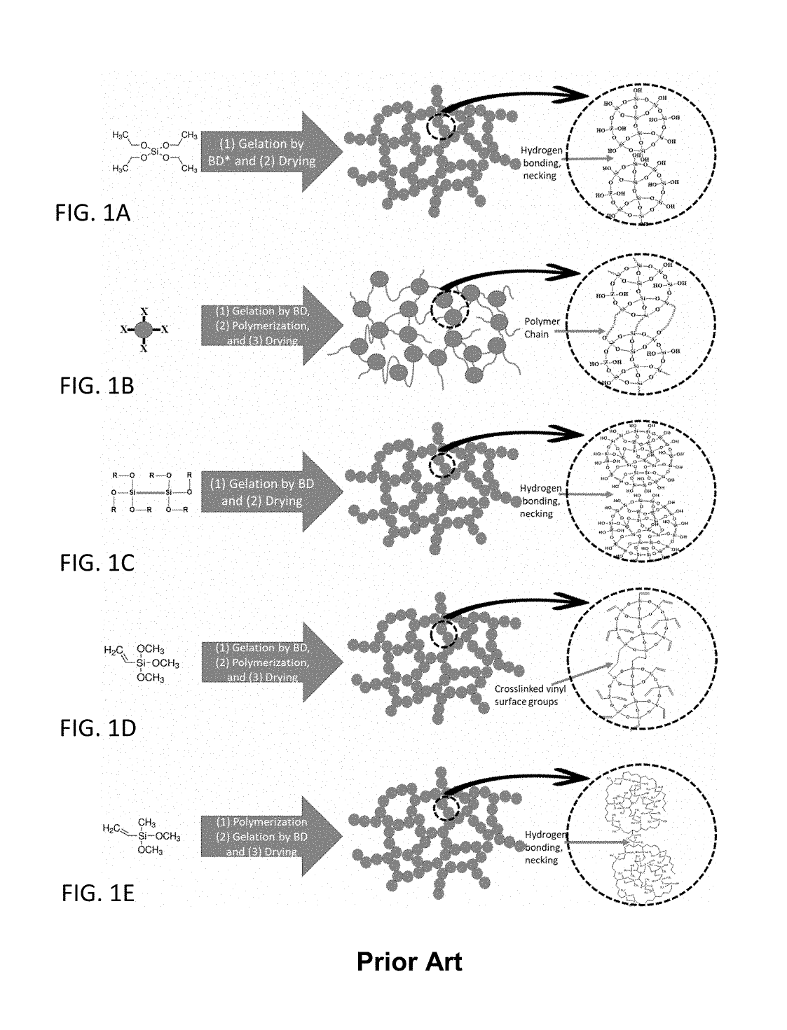

This new class of hybrid aerogels has a unique structure and is different from the previous aerogels. Its 3-D continuous network homogeneously and uniformly distributes organic and inorganic components in a nonparticulate structure. Polymer crosslinked aerogels (see FIG. 1B) cannot do this. In a polymer crosslinked aerogel, two distinct phases exist: organic only phases and inorganic only phases. These significantly improve the mechanical properties. When a force is applied in the non-homogeneous phase, the weak phase, such the organic phase, fails first. However, in the unique structure of the new aerogel, all of the organic phases are uniformly reinforced by silica linkages.

In addition, unlike conventional hybrid aerogels, which have a particulate structure, the newly claimed hybrid aerogel structure is more like an open-cell foam. That is, the pores are separated by solid struts, and there is no particulate structure. These struts help to uniformly distribute the applied forces throughout the structure and to avoid creating a stress concentration point.

There is another unique feature of the new hybrid aerogel in which the average pore sizes can be almost independent of the density. In conventional aerogels, the pore size depends on the aerogel's density [34,44], meaning that the pore size typically increases as the density decreases. But in the present aerogel, the pore size distribution typically does not change with a decreased density, although we can create larger pores intentionally at a lower density by using a different kind of solvent for example.

Owing to their unique continuous nonparticulate, reticulated structure, the newly invented aerogels can have extremely low densities. Because this unique structure can resist capillary forces during drying more and, thereby, can prevent shrinking, a much larger amount of solvent can be used to achieve ultra-low densities.

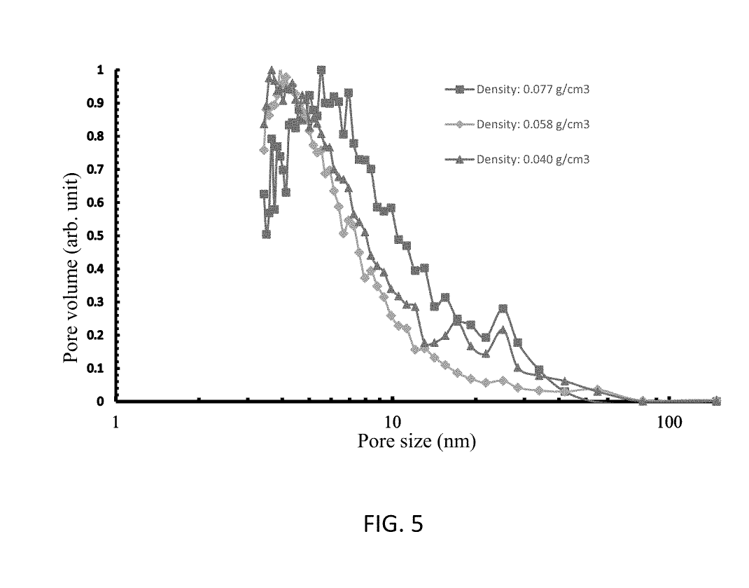

Compared to Kanamori's recent progress in the hybrid aerogel structure based on the PVPMS material [34], from the structural point of view, the newly invented hybrid aerogel has four unique and novel features. Firstly, the newly invented aerogel has a unique nonparticulate, reticulate structure whereas the PVPMS aerogel has a particulate structure. Secondly, in this new invention, pores are significantly smaller (4 to 9 nm) (which is determined by cryoporometry method using cyclohexane [45]), whereas the smallest achieved pore size in the PVPMS aerogel is 28 nm. Therefore, the newly invented aerogels exhibit significantly lower thermal conductivity even at the same density. Thirdly, in the newly invented aerogel, the average pore size is independent of the density as shown in FIG. 5, whereas in the PVPMS aerogel like any other particulate aerogels, the pore sizes are a function of the density [44]. Fourthly, the density of the newly invented aerogels can be very low because of the nonparticulate nature whereas the PVPMS aerogel cannot have a very low density. The minimum density that the present invention have achieved so far from the newly invented aerogels is 0.01 g·cm⁻³ (which is equivalent to 200 times expansion ratio), but the density may even go below this number. In contrast, the minimum density of the PVPMS aerogel is 0.16 g·cm⁻³ because of its particulate structure, in which a large void fraction cannot be achieved due to the low content of particle-to-particle connections without structural collapse.

### Properties

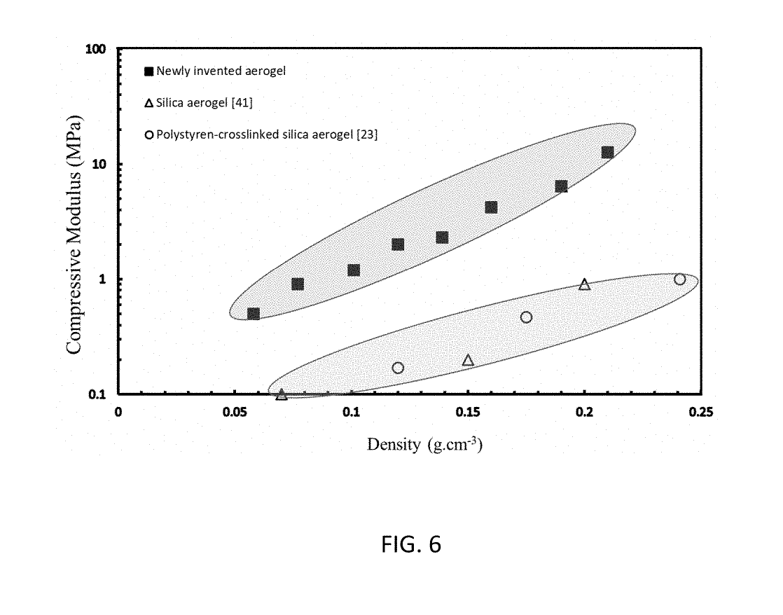

These unique nonparticulate structures give the newly invented hybrid aerogels much better mechanical properties than the previous aerogels with particulate structures of the same density. The particulate structure with a high degree of non-homogeneity typically can cause stress concentrations in the connections during deformation and, therefore, the mechanical properties are not good. Unlike the particulate structure with a high degree of non-homogeneity, the newly invented aerogels are free from the non-homogeneity of the particle-to-particle connections. Consequently, the overall network of the newly invented aerogels distributes the force uniformly throughout the network structure during deformation. Therefore, the newly invented aerogels should have superior mechanical properties compared to the particulate aerogels. FIG. 6 shows that the newly invented aerogels exhibit almost an order of magnitude higher stiffness, in comparison with the previous particulate aerogels, at any given density.

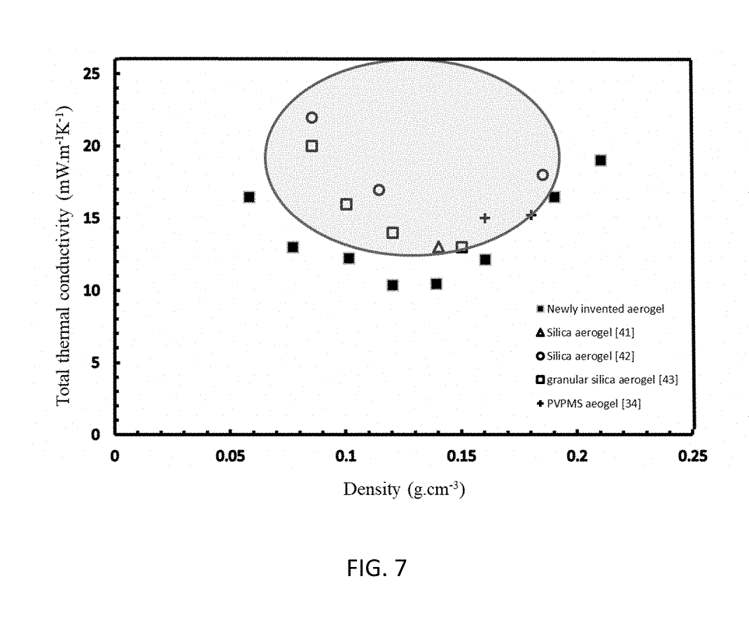

In addition to the outstanding mechanical properties, the newly invented hybrid aerogels also have a much lower thermal conductivity at a given density. The extremely small average pore size (ranging 4 to 9 nm) and the independent pore sizes in various densities, as mentioned above, help to maintain its insulation performance. As shown in FIG. 7, the newly invented aerogels exhibit a lower thermal conductivity than the particulate aerogels at a given density. For example, at the density of 0.12 g·cm⁻³, the newly invented nonparticulate hybrid aerogels show the lowest thermal conductivity of 10.34 mW·m⁻¹K⁻¹, whereas the minimum reported total thermal conductivity of PVPMS aerogel is 15 mW·m⁻¹K⁻¹ at the density of 0.16 g·cm⁻³.

Very thin nonparticulate hybrid aerogels with a low density, down to 0.01 g·cm⁻³, can be produced very quickly because of the relatively short diffusion time required for drying. The conventional particulate thin-film aerogels may not be functional because of the poor mechanical properties. Even if some particulate aerogels may successfully be made in a flexible thin film shape, the weak mechanical properties of the particulate structure will limit the applications. By contrast, we can easily make functional thin-film aerogels from this art, because of the significantly enhanced mechanical properties. This thin hybrid aerogel is strong and, therefore, can be self-standing. Because of the thin thickness, the upper- and lower-end stresses will not exceed the yield strength and, therefore, the thin film will exhibit an elastic behavior even for a large deformation. Therefore, this thin aerogel will be flexible and elastic. Even industry-scale production of the ultralight and strong aerogel films would not be difficult.

### Example 1: PE-Based Silica Aerogels

This example describes: (i) the synthesis methodology of the nonparticulate PE-based silica aerogel precursor with high molecular weight, (ii) the aerogel manufacturing process, and (iii) the properties of the produced hybrid aerogel. All chemical substances were purchased from Sigma-Aldrich.

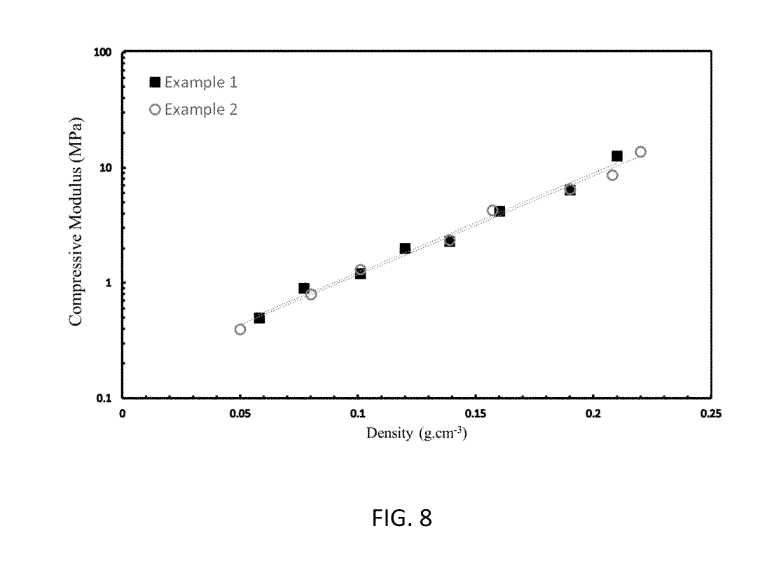

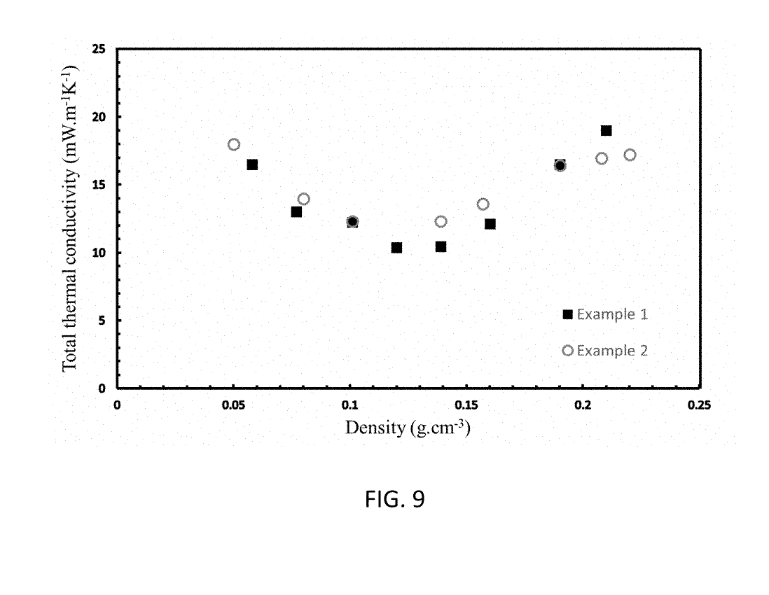

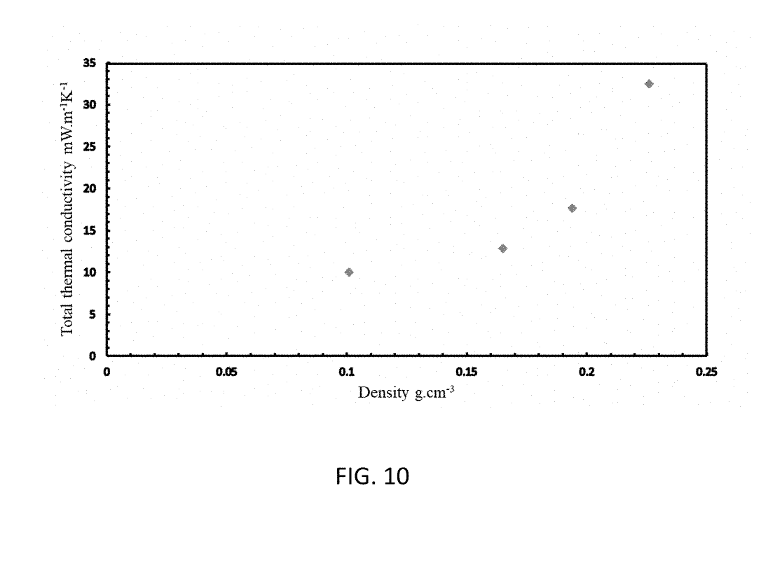

A 5.97 g amount of Di-tert-butyl peroxide was added to 60 g of liquid vinyl trimethoxysilane and was followed by vigorous stirring at 163° C. for 2 hours in a nitrogen atmosphere. The degree of polymerization for this processing condition was 130. However, by changing the thermal initiator or the processing conditions, a different molecular weight could be obtained. To obtain the desired final aerogel density after the CO₂ supercritical extraction, a specific amount of a polymeric precursor and a catalyst must be added to a specific amount of a solvent (such as ethanol). For instance, 4 g of the polymeric precursor was added to 20 ml of ethanol, and then 5.4 g of ammonia was added to the above-noted mixture at 40° C. The mixture gelled after 18 min. The density of the silica aerogel monolith obtained from this example after the CO₂ extraction was 0.157 g·cm⁻³. This aerogel, unlike other members of the silica aerogel family, had no trace of a particulate structure, as expected. The aerogel structure is more like an open-cell polymeric foam with a fully co-continuous distribution of a solid skeleton and pores. FIGS. 8 and 9, respectively, show the compressive modulus and the total thermal conductivity of the PE-based silica aerogel at various densities. Note that the same data are used earlier for comparison with previous aerogel properties in FIG. 6 and FIG. 7.

### Example 2: Significant Reduction of the Cost with Thermal Initiator Kind Using PE-Based Silica Aerogels

This example describes how the synthesis cost of the PE-based silica aerogels shown in Example 1 could be reduced significantly by using a different thermal initiator with negligible sacrifice to the mechanical and thermal properties.

We added 5.97 g of dicumyl peroxide (instead of Di-tert-butyl peroxide) as a thermal initiator to 60 g of vinyl trimethoxysilane and followed this with vigorous stirring at 123° C. for 1 hour in a nitrogen atmosphere. The degree of polymerization for this processing condition was 67. To obtain the desired final aerogel density after the CO₂ supercritical extraction, a certain amount of polymeric precursor and catalyst must be added to a specific solvent such as ethanol. For instance, 1.6 g of this polymeric precursor was dissolved in 20 ml ethanol, and then 1.9 g of ammonia was added to the solution at 40° C. After the drying stage, the aerogel had a density of 0.077 g·cm⁻³. The compressive modulus and the total thermal conductivity of these PE-based silica aerogels at various densities are shown in FIGS. 8 and 9, respectively, together with those data of Example 1 for comparison. It seems that the compressive strength data were equivalent but the total thermal conductivities of Example 2 are slightly higher than those of Example 1.

### Example 3: Polyether-Based Silica Aerogels

This example describes the synthesis methodology of the polyether-based silica aerogel precursor and the corresponding hybrid-aerogel manufacturing process.

To make a polyether-based silica aerogel precursor, (3-glycidyloxypropyl) trimethoxysilane (GPTMS), boron trifluoride diethyl etherate, and ethyl ether were used as the monomer, the catalyst, and the solvent, respectively. Through a cationic ring-opening polymerization, a polymeric structure of GPTMS was synthesized. A 60-g amount of GPTMS was dissolved in 40 ml ethyl ether and cooled down to 0° C. using an ice bath in a nitrogen atmosphere. Then, 0.4 ml of the catalyst was added dropwise to the solution and was followed by vigorous stirring for 2 hours. The final mixture was placed in a vacuum to remove the ethyl ether. According to the GPC data, the degree of polymerization in this condition was 29. 2 g of the polymeric precursor was added to 20 ml of ethanol, and then 1.6 g of ammonia was then added to the above-noted mixture at 40° C. The mixture gelled after 20 seconds. After the wet gel was dried, the final aerogel was obtained. It should be noted that the void fraction of polyether-based silica aerogels was decreased significantly because of the unexpected high shrinkage during drying. It seems that the higher organic content of 40 wt. % may have caused this shrinkage. It was also claimed that the flexible oxygen bonds in the main backbone may have caused the shrinkage. The polyether-based precursor has many flexible oxygen bonds in the main backbone, which may have caused a large shrinkage during the drying phase. Table 1 shows the amount of shrinkage, the thermal conductivities, and the mechanical properties of the polyether-based silica aerogel.

TABLE 1
Physical, thermal and mechanical properties of polyether-based silica aerogels.

| | Target | Actual | Shrinkage | Thermal | Compressive |
|---|---|---|---|---|---|
| Sample | density | density | (%) | conductivity | Modulus |
| 1 | 0.1 g · cm⁻³ | 0.253 g · cm⁻³ | 153 | 43 mW · m⁻¹K⁻¹ | 4.5 MPa |
| 2 | 0.156 g · cm⁻³ | 0.357 g · cm⁻³ | 128 | 59 mW · m⁻¹K⁻¹ | 12.53 MPa |

### Example 4: Reduction of the Shrinkage Using Co-Precursor-Based Silica Aerogels

This example describes how the shrinkage of the polyether-based silica aerogels shown in Example 3 could be reduced significantly by using a different co-precursor with a lower organic content and without the flexible oxygen bonds. Since the PE-based silica aerogels have a lower organic content of 27 wt. % and have no oxygen bonds, we decreased the content of the polyether-based silica precursor by mixing some PE-based silica material for the purpose of decreasing the shrinkage of the polyether-based silica aerogel. Table 2 shows the shrinkage and the mechanical and insulation properties of these hybrid aerogels made from polyether/PE-based silica precursor. Table 2 shows that the shrinkage of the polyether-based silica aerogels with a modified precursor, by adding various contents of the PE-based material to form a co-precursor of polyether and PE-based silica aerogel, reduced significantly as well.

Polymeric precursors were prepared according to Example 1 and Example 3. Then, 3.6 g of the polyether-based precursor and 0.4 g of the PE-based precursor were dissolved in 20 ml of ethanol. The solution's temperature increased to 40° C., and then 3.2 g of ammonia solution (catalyst) was then added to it. After ten minutes, the solution had gelled. The density of the silica aerogel monolith obtained from this example, after the CO₂ extraction, was 0.24 g·cm⁻³ and the total thermal conductivity was 24 mW·m⁻¹·K⁻¹.

TABLE 2
Physical, thermal and mechanical properties of polyether/PE-based silica

| | | Target | Actual | | Thermal | Compressive |
|---|---|---|---|---|---|---|
| | PE Modifier | density | density | Shrinkage | conductivity | Modulus |
| Sample | (wt. %) | (g · cm⁻³) | (g · cm⁻³) | (%) | (mW · m⁻¹ · K⁻¹) | (MPa) |
| 1 | 10 | 0.156 | 0.24 | 53 | 24 | 2.42 |
| 2 | 20 | 0.156 | 0.18 | 15 | 19 | 2.62 |
| 3 | 30 | 0.156 | 0.17 | 9 | 17 | 2.104 |
| 4 | 40 | 0.156 | 0.16 | 2.5 | 16 | 2.633 |

### Example 5: PMMA-Based Silica Aerogels

This example describes the synthesis methodology of polymethylmethacrylate (PMMA)-based silica aerogel precursors and the corresponding nonparticulate hybrid-aerogel manufacturing process. The creation of a nonparticulate hybrid-aerogel structure would depend mainly on the phase-separation mechanism (i.e., spinodal decomposition) and, therefore, a nonparticulate hybrid-aerogel structure can be created from any polymeric precursor with different backbone chemistry. In order to demonstrate this possibility, a PMMA-based polymeric precursor was used to produce a nonparticulate hybrid aerogel.

We added 3 g of dicumyl peroxide to 60 g of 3-(Trimethoxysilyl)propyl methacrylate and followed this with vigorous stirring at 163° C. for 20 minutes in a nitrogen atmosphere. The degree of polymerization for this processing condition was 162. To obtain the desired final aerogel density after the CO₂ supercritical extraction, a certain amount of polymeric precursor and catalyst must be added to a specific amount of solvent, such as ethanol. For example, when 1.6 g of the polymethylmethacrylate-based precursor was added to 20 ml of ethanol, the solution's temperature increased to 40° C., and then 1.8 g of ammonia (catalyst) was added to it. After one hour, the solution had gelled. The density of the silica aerogel monolith obtained from this example after the CO₂ extraction was 0.101 g·cm⁻³ and total thermal conductivity is 10 mW·m⁻¹·K⁻¹. It should be noted that the high absorption coefficient of PMMA must have decreased the radiation conductivity [46]

This invention has been fully described here. The same method can be applied across a wide range of equivalent parameters, materials, concentrations, and temperatures without departing from the spirit and scope of this invention, and without undue experimentation by a specially trained person. While this invention still has the potential to be further developed, this disclosure is made herein to address any variations, adaptations, and applications to which it applies or may be applied as an essential part.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the components of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

### REFERENCES

[1] J. C. Williams, M. AB. Meador, L. McCorkle, C. Mueller, N. Wilmoth, Synthesis and Properties of Step-Growth Polyamide Aerogels Crosslinked with Triacid Chlorides, Chem. Mater. 26, (2014), 4163-4171
[2] Sh. Wu, A. Du, Sh. Huang, W. Sun, Y. Xiang, B. Zhou, Solution-processable polyimide aerogels with high hydrophobicity, Materials Letters 176 (2016) 118-121.
[3] X. Wang, S. C. Jana, Syndiotactic polystyrene aerogels containing multi-walled carbon Nanotubes, Polymer 54 (2013) 750-759.
[4] S. S. Kistler, Coherent expanded aerogels and jellies, Nature 127 (1931) 741-741.
[5] S. S. Kistler, Coherent expanded aerogels, J. Phys. Chem. 36 (1932) 52-64.
[6] G. Nicolaon, S. Teichner, New preparation process for silica xerogels and aerogels, and their textural properties, Bull. Soc. Chim. Fr. 5 (1968) 1900-1906.
[7] H. Cai, W. Mu, W. Liu, X. Zhang, Y. Deng, Sol-gel synthesis highly porous titanium dioxide microspheres with cellulose nanofibrils-based aerogel template, Inorganic Chemistry Communications 51 (2015) 71-74
[8] R. Sui, A. S. Rizkalla, P. I A. Charpentier, Direct Synthesis of Zirconia Aerogel Nanoarchitecture in Supercritical CO₂, Langmuir 22 (2006) 4390-4396.
[9] N. Ogzer, J. P. Cronin, Y. Yao, A. P. Tomsia, Optical properties of so-gel deposited Al₂O₃ films, Solar Energy Materials & Solar Cells 59 (1999) 355-366
[10] J. H. She, T. Ohji, Porous mullite ceramics with high strength, J. Mater. Sci. Lett. 31 (2002) 1833-1834.
[11] H.-S. Ma, A. P. Roberts, J.-H. Prevost, R. Jullien, G. W. Scherer, Mechanical structure-property relationship of aerogels, J. Non-Cryst. Solids 277 (2000) 127-141.
[12] H. A Omranpour, S. Motahari, Effects of processing conditions on silica aerogel during aging: Role of solvent, time and temperature, J. Non-Cryst. Solids 379 (2013) 7-11.
[13] F. He, H. Zhao, X. Qu, C. Zhang, W. Qiu, Modified aging process for silica aerogel, J. of materials processing technology 209 (2009) 1621-1626.
[14] A. Bisson, A. Rigacci, D. Lecomte, E. Rodier, P. Achard, Drying of silica gels to obtain aerogels: phenomenology and basic techniques, Dry. Technol. 21 (2003) 593-628.
[15] G. W Scherer, Aging and drying of gels, J. Non-Cryst. Solids 100 (1988) 77-92.
[16] J. Martin, B. Hosticka, C. Lattimer, P. M. Norris, Mechanical and acoustical properties as a function of PEG concentration in microporous silica gel, J. Non-Cryst. Solids 285 (2001) 222-229.
[17] M. A. B. Meador, E. F. Fabrizzio, F. Ilhan, A. Dass, G. Zhang, P. Vassilaras, J. C. Johnston, N. Leventis, Crosslinking amine modified silica aerogels with epoxies: mechanically strong lightweight porous materials, Chem. Mater. 17 (2005) 1085-1098.
[18] M. A. B. Meador, B. N. Nguyen, D. Quade, S. L. Vivod, Epoxy reinforced aerogels made using a streamlined process, ACS Appl. Mater. Interfaces 2 (2010) 2162-2168.
[19] N. Leventis, A. Sadekar, N. Chandrasekaran, C. Sotiriou, N. Leventis, Click synthesis of monolithic silicon carbide aerogels from polyacrylonitrile-coated 3D silica networks, Chem. Mater. 22 (2010) 2790-2803.
[20] J. K. Lee, G. L. Gould, W. Rhine, Polyurea based aerogel for a high performance thermal insulation material, J. Sol-Gel Sci. Technol. 49 (2009) 209-220.
[21] L. A. Capadona, M. A. B. Meador, A. Alunni, E. F. Fabrizio, P. Vassilaras, N. Leventis, Flexible, low-density polymer crosslinked silica aerogels, Polymer 47 (2006) 5754-5761.
[22] S. L. Vivod, M. A. B. Meador, B. N. Nguyen, R. Perry, Flexible di-isocyanate cross-linked silica aerogels with 1,6-bis(trimethoxysilyl)hexane incorporated in the underlying silica backbone, Polym. Prepr. 50 (2009) 119-120.
[23] B. N. Nguyen, M. A. B. Meador, M. E. Tousley, B. Shonkwiler, L. Mccorkle, D. A. Scheiman, A. Palczer, Tailoring elastic properties of silica aerogels cross-linked with polystyrene, ACS Appl. Mater. Interfaces 1 (2009) 621-630.
[24] U. F. Ilhan, E. F. Fabrizio, L. Mccorkle, D. A. Scheiman, A. Dass, A. Palczer, M. A. B. Meador, J. C. Johnston, N. Leventis, Hydrophobic monolithic aerogels by nanocasting polystyrene on amine-modified silica, J. Mater. Chem. 16 (2006) 3046-3054.
[25] J. P. Randall, M. A. B. Meador, S. C. Jana, Polymer reinforced silica aerogels: effects of dimethyldiethoxysilane and bis(trimethoxysilylpropyl) amine as silane precursors, J. Mater. Chem. A, 1 (2013) 6642-6652.
[26] B. N. Nguyen, M. A. B. Meador, A. Medoro, V. Arendt, J. Randall, L. McCorkle, B. Shonkwiler, Elastic Behavior of methyltrimethoxysilane based aerogels reinforced with Tri-Isocyanate, J. Applied Materials and Interfaces, 2 (2010) 1430-1443.
[27] D. J. Boday, R. J Stover, B. Muriithi, D. A. Loy, Mechanical properties of hexylene- and phenylene-bridged polysilsesquioxane aerogels and xerogels. J. Sol-Gel Sci. Technol. 61 (2012) 144-150
[28] Y. Aoki, Low-density, transparent aerogels and xerogels based on hexylene-bridged polysilsesquioxane with bendability. J. Sol-Gel Sci. Technol. 81 (2017) 42-51.
[29] D. A. Loy, G. A Jamison. Alkylene-bridged polysilsesquioxane aerogels: highly porous hybrid organic-inorganic materials. J. Non. Cryst. Solids 186, 44-53 (1995).
[30] D. A. Loy, K. A. Obrey-DeFriend, K. V. Wilson Jr, M. Minke, B. M. Baugher, C. R. Baugher, D. A. Schneider, G. M. Jamison, K. J. Shea Influence of the alkoxide group, solvent, catalyst, and concentration on the gelation and porosity of hexylene-bridged polysilsesquioxanes. J. Non. Cryst. Solids 362, 82-94 (2013)
[31] Sh. Yun, H. Luoab Y. Gao, Low-density, hydrophobic, highly flexible ambient-pressure-dried monolithic bridged silsesquioxane aerogels, J. Mater. Chem. A, 3 (2015) 3390-3398.
[32] D. J. Boday, R. J. Stover, B. Muriithi, D. A. Loy, Mechanical properties of hexylene- and phenylene-bridged polysilsesquioxane aerogels and xerogels J. Sol-Gel Sci. Technol. 61 (2012) 144-150.
[33] T. Shimizu, K. Kanamori, A. Maeno, H., Kaji, C. M. Doherty, P. Falcaro, K. Nakanishi, Transparent, Highly Insulating Polyethyl- and Polyvinylsilsesquioxane Aerogels: Mechanical Improvements by Vulcanization for Ambient Pressure Drying, J. Chemistry of materials, 28 (2016) 6860-6868.
[34] G. Zu, T. Shimizu, K. Kanamori, Y. Zhu, A. Maeno, H. Kaji, J. Shen, K. Nakanishi, Transparent, Superflexible Doubly CrossLinked Polyvinylpolymethylsiloxane Aerogel Superinsulators via Ambient Pressure Drying, ACS Nano, DOI: 10.1021/acsnano.7b07117.
[35] S. He, Y. Zhang, X. Shi, Y. Bi, X. Luo, L. Zhang, Rapid and facile synthesis of a low-cost monolithic polyamide aerogel via sol-gel technology, Materials Letters 144 (2015) 82-84.
[36] Y. Chen, G. Shao, Y. Kong, X. Shen, Sh. Cui, Facile preparation of cross-linked polyimide aerogels with carboxylic functionalization for CO2 capture, Chemical Engineering Journal 322 (2017) 1-9.
[37] T. Ning, G. Yang, W. Zhao, X. Liu, One-pot solvothermal synthesis of robust ambient-dried polyimide aerogels with morphology-enhanced superhydrophobicity for highly efficient continuous oil/water separation, Reactive and Functional Polymers 116 (2017) 17-23.
[38] M. Alshrah, M. Ph. Tran, P. Gong, H. E. Naguib, C. B. Park, Development of high-porosity resorcinol formaldehyde aerogels with enhanced mechanical properties through improved particle necking under CO2 supercritical conditions, Journal of Colloid and Interface Science 485 (2017) 65-74
[39] M. Nguyen, L. H. Dao, Effects of processing variable on melamine-formaldehyde aerogel formation, Journal of Non-Crystalline Solids 225 1998 51-57.
[40] J. Fricke, Aerogels-highly tenuous solids with fascinating properties, J. Non-Cryst. Solids 100 (1988) 169-173.
[41] Z. DENG, J. WANG, J. WEI, J. SHEN, B. ZHOU, L. CHEN, Physical Properties of Silica Aerogels Prepared with Polyethoxydisiloxanes, J. Sol-Gel Sci. Technol. 19 (2000) 677-680.
[42] G. Wei, Y. Liu, X. Zhang, F. Yu, X. Du, Thermal conductivities study on silica aerogel and its composite insulation materials, International Journal of Heat and Mass Transfer 54 (2011) 2355-2366.
[43] A. Neugebauer, K. Chen, A. Tang, A. Allgeier, L. R. Glicksman, L. J. Gibson, Thermal conductivity and characterization of compacted, granular silica aerogel, Energy and Buildings 79 (2014) 47-57.
[44] L. W. Hrubesh, R. W. Pekala, Thermal properties of organic and inorganic aerogels, Journal of Materials Research, 9 (1994) 731-738.
[45] J. D. Jeon, S. J. Kim, S. Y. Kwak, 1H nuclear magnetic resonance (NMR) cryoporometry as a tool to determine the pore size distribution of ultrafiltration membranes, Journal of Membrane Science 309 (2008) 233-238.
[46] G. Wang, Ch. Wang, J. Zhao, G. Wang, C. B. Park, G. Zhao, Modelling of thermal transport through a nanocellular polymer foam: toward the generation of a new superinsulating material, Nanoscale, 9 (2017) 5996-6009.

What is claimed is:

1) A process for preparing a hybrid aerogel having a continuous nonparticulate-reticulated structure comprising of a polymeric precursor that is crosslinked by a linkage without forming a particulate structure, said process comprising steps of:
a) dissolving the polymeric precursor in a solvent to form a solution, wherein said polymeric precursor comprising of (R1O)4-XM(R2)X, wherein M is selected from the group consisting of silicon, titanium, zirconium, or aluminum; R1O is a hydrolyzable group to create a covalent M-O-M bonding through a sol-gel reaction; R2 has any structure which carry at least one functional group to start a polymerization reaction or/and is grafted to a polymeric chain;
b) adding a high concentration of a nonsolvent and a catalyst to the solution, wherein adding reaction temperature is between 20° C. to 60° C. to form a wet gel, and
c) drying the wet gel.

2) The process of claim 1, wherein the hybrid aerogel is any one of a hybrid silica aerogel having a silica linkage, a hybrid titanium oxide aerogel having a titanium oxide linkage, a hybrid zirconia oxide aerogel having a zirconia oxide linkage or a hybrid aluminum oxide aerogel having an aluminum oxide linkage.

3) The process of claim 1, wherein the solvent is selected from the group consisting of methanol, ethanol, butanol, hexanol, acetone, tetrahydrofuran or a combinations thereof.

4) The process of claim 1, wherein the high concentration catalyst is selected from the group consisting of an acid family member, a base family member or a neutral silica catalyst.

5) The process of claim 1, wherein a degree of polymerization of the polymeric precursor is preferably between 20° C. to 140° C.

6) A process for preparing a reinforced-nanoparticulate hybrid aerogel structure with a plurality of fibers/particles comprising steps of:
a) dissolving a polymeric precursor with fibers and/or particles in a solvent to form a solution, wherein said polymeric precursor is represented by a formula (R1O)4-XM(R2)X and wherein M is silicon, titanium, zirconium, or aluminum; the R1O is a hydrolyzable group to create a covalent M-O-M bonding through a sol-gel reaction; R2 has any structure which carry at least one functional group to start a polymerization reaction or/and is grafted to a polymeric chain;
b) adding a high concentration of a nonsolvent and a catalyst to the solution wherein adding reaction temperature is between 20° C. to 60° C. to form a reinforced wet gel, and
c) drying the reinforced wet gel.

7) The process of claim 6, wherein the reinforced-nanoparticulate hybrid aerogel structure is selected from the groups consisting of a reinforced nanoparticulate hybrid silica aerogels, a reinforced nanoparticulate hybrid titanium oxide aerogels, a reinforced nanoparticulate hybrid zirconium oxide aerogels, or a reinforced nanoparticulate hybrid aluminum oxide aerogels.

8) The process of claim 6, wherein the solvent is selected from the groups consisting of methanol, ethanol, butanol, hexanol, acetone, tetrahydrofuran or the combinations thereof.

9) The process of claim 6, wherein the high concentration catalyst is selected from the groups consisting of an acid family member, a base family member or a neutral silica catalyst.

10) The process of claim 6, wherein said process being used to manufacture a highly insulative glass (HIG), an insulative panel, a thin film for windows, or an insulative glass without nano-sized voids.

11) The process of claim 6, wherein a degree of polymerization of the polymeric precursor is preferably 20° C. to 140° C.

12) A composition of a polymeric precursor represented by a formula
(R₁O)_{4-X}M(R₂)_{X}
wherein M is silicon, titanium, zirconium, or aluminum; R₁O is a hydrolyzable group to create a covalent M-O-M bonding through a sol-gel reaction; R₂ has any structure which carry at least one functional group to start a polymerization reaction or/and is grafted to a polymeric chain.

13) The composition of a polymeric precursor of claim 12, wherein number of silicon atoms per each molecule varies in a wide range from 10 to 1000, preferably 20 to 200 and silicon atoms are side groups which distributed along a chain.

14) The composition of a polymeric precursor of claim 12, wherein said polymerization reaction is selected from the groups consisting of a free radical polymerization, an anionic and cationic polymerization, a ring opening polymerization, a click polymerization and an atom transfer polymerization.

15) A preparation process for the polymeric precursor comprising of the steps:
a) homopolymerization of a R₁O or the copolymerization of them with each other, or with any other co-monomer at any concentration through a polymerization method, and
b) grafting an R₂ to a polymeric chain,
wherein said is R₁O a hydrolyzable group to create a covalent M-O-M bonding through a sol-gel reaction and R₂ has any structure which carry at least one functional group to start a polymerization reaction or/and is grafted to a polymeric chain.

16) A class of hybrid aerogel with a continuous nonparticulate reticulated structure comprising a polymeric framework crosslinked by a linkage.

17) The class of claim 16, wherein the hybrid aerogel is selected from the groups consisting of a hybrid silica aerogel having a silica linkage, a hybrid titanium oxide aerogel having a titanium oxide linkage, a hybrid zirconia oxide aerogel having a zirconia oxide linkage or a hybrid aluminum oxide aerogel having an aluminum oxide linkage.

18) The class of claim 16, wherein said hybrid aerogel having a void fraction between 75% to 98%, thermal conductivity of less than 30 mW·m⁻¹·K⁻¹ under one atmospheric pressure and ambient temperature, and an average pore size is almost independent of a density.

19) An insulated product comprising a class of hybrid aerogel with a continuous nonparticulate reticulated structure comprising a polymeric framework crosslinked by a linkage.

20) The insulated product of claim 19, wherein the hybrid aerogel is selected from the groups consisting of a hybrid silica aerogel having a silica linkage, a hybrid titanium oxide aerogel having a titanium oxide linkage, a hybrid zirconia oxide aerogel having a zirconia oxide linkage or a hybrid aluminum oxide aerogel having an aluminum oxide linkage.

21) The insulated product of claim 19, wherein said insulated product is selected from the groups consisting of a highly insulative glass (HIG), an insulative panel, an insulative glass, and a thin film.
